(19) United States
(12) Patent Application Publication
(10) Pub. No.: US 2022/0076909 A1
(43) Pub. Date: Mar. 10, 2022

(54) Electromagnetic Inertial Switch

(71) Applicant: LOON LLC, Mountain View, CA (US)

(72) Inventor: Nicolas Bergeron, San Mateo, CA (US)

(73) Assignee: LOON LLC, Mountain View, CA (US)

(21) Appl. No.: 17/016,268

(22) Filed: Sep. 9, 2020

(51) Int. Cl. H01H 35/14; B60R 21/0136; H01H 51/06; B60R 21/0132

(52) U.S. Cl. CPC H01H 35/143; B60R 21/0136; B60R 2021/01325; B60R 21/0132; H01H 51/06

(57) ABSTRACT

The technology relates to techniques for an electromagnetic inertial switch. An electromagnetic inertial switch can include an electrically conductive and magnetic mass located within a cavity, where portions of the cavity are electrically conductive and are electrically coupled to terminals of the electromagnetic inertial switch. A first magnetic field can be configured to apply a first force on the mass to attract the mass towards a first location, and a second magnetic field can be configured to apply a second force on the mass to attract the mass towards a second location. The electromagnetic inertial switch can be in a first electrical state when the mass is in the first location, and in response to an acceleration event greater than a threshold acceleration, the mass can move to the second location, thereby changing the electromagnetic inertial switch to a second electrical state.

### BACKGROUND OF INVENTION

Inertial switches, or acceleration switches, are electrical switches that change state in response to an event that generates high g-forces. Typically, inertial switches are used to enable or disable an electrical or electromechanical system in response to an acceleration event. Inertial switches are used in a wide range of applications, such as in automotive, aircraft, space and military applications. For instance, inertial switches are used in cars to activate vehicle safety systems, such as pre-tensioning safety belts and deploying airbags, in the event of an accident.

Commonly, inertial switches contain a mass trapped within a spring-loaded cage. Upon experiencing an acceleration event, such as a vehicular accident, the mass will move relative to the cage causing the cage to spring open, thereby opening or closing an associated switch. Such inertial switches can then be reset by physically pressing the mass back into the cage.

### BRIEF SUMMARY

The present disclosure provides techniques for an electromagnetic inertial switch. An electromagnetic inertial switch, can include a mass that is electrically conductive and magnetic; a cavity comprising a major surface and a perimeter side, wherein: a portion of the major surface of the cavity is electrically conductive and is electrically coupled to a first terminal of the electromagnetic inertial switch, and a portion of the perimeter side of the cavity is electrically conductive and is electrically coupled to a second terminal of the electromagnetic inertial switch; a first magnetic field configured to apply a first force on the mass to attract the mass towards the center of the cavity; and a second magnetic field configured to apply a second force on the mass to attract the mass towards the portion of the perimeter side; wherein: the mass being suspended within the cavity by the first magnetic field such that the electromagnetic inertial switch is in a high resistance state at rest and in response to an acceleration event less than a threshold acceleration; and the mass being configured to be displaced from the center of the cavity, and held against the perimeter side by the second magnetic field, the mass further configured to make electrical contact with both the portion of the major surface and the portion of the perimeter side such that the electromagnetic inertial switch is in a low resistance state in response to an acceleration event greater than a threshold acceleration. In an example, the electromagnetic inertial switch is configured to be reset to the high resistance state by moving the second magnetic field away from the cavity such that the first magnetic field causes the mass to be suspended within the center of the cavity. In another example, the mass closes a circuit by forming a conductive path between the portion of the major surface and the portion of the perimeter side. In another example, the mass is approximately spherical. In another example, the electromagnetic inertial switch further comprises a second major surface of the cavity, wherein: a portion of the second major surface of the cavity is electrically conductive and is electrically coupled to a third terminal of the electromagnetic inertial switch; and the portion of the major surface of the cavity and the portion of the second major surface of the cavity are located on opposing sides of the cavity. In another example, the electromagnetic inertial switch further comprises a second portion of the perimeter side that is electrically conductive and is electrically coupled to a third terminal of the electromagnetic inertial switch; and a third magnetic field configured to apply a second force on the mass to attract the mass towards the second portion of the perimeter side. In another example, the cavity is shaped like a cylinder with circular bases having relatively small diameters compared to the length of the cylinder. In another example, the cavity is shaped like a right rectangular prism with one relatively long dimension and two relatively short dimensions. In another example, the cavity is shaped like a cylinder with circular bases having relatively large diameters compared to the height of the cylinder. In another example, the acceleration event has a magnitude of approximately 0.5 g to 100 g. In another example, the electromagnetic inertial switch is coupled to a lighter than air vehicle and configured to actuate a flight termination system in response to an acceleration event greater than a threshold acceleration.

A method of actuating an electrical system in response to an acceleration event, can include: providing an electromagnetic inertial switch comprising an electrically conductive and magnetic mass located within a cavity, a first electrical contact, a second electrical contact, a first magnet, and a second magnet; attracting the mass to the first magnet such that the mass is in a first location prior to a sufficient acceleration event, causing the switch to be in a first state; accelerating the switch in a direction with a magnitude sufficient to displace the mass from the first location; and attracting the mass to the second magnet such that the mass is held in a second location after the acceleration event, causing the switch to be in a second state, wherein the mass forms a conductive path between the first electrical contact and the second electrical contact in the second state to actuate an electrical system. In an example, the above method further comprises resetting the electromagnetic inertial switch by moving the second magnet away from the cavity, such that the mass is attracted back to the first location by the first magnet. In another example, the mass is approximately spherical. In another example, the first electrical contact comprises a portion of a major surface of the cavity that is electrically conductive and the second electrical contact forms a portion of a perimeter side of the cavity that is electrically conductive. In another example, the cavity is shaped like a cylinder with circular bases having relatively small diameters compared to the length of the cylinder. In another example, the cavity is shaped like a right rectangular prism with one relatively long dimension and two relatively short dimensions. In another example, the cavity is shaped like a cylinder with circular bases having relatively large diameters compared to the height of the cylinder. In another example, the magnitude of the acceleration of the switch is from 0.5 g to 100 g. In another example, the electromagnetic inertial switch is coupled to a lighter than air vehicle and actuates a flight termination system in response to an acceleration event greater than a threshold acceleration.

### BRIEF DESCRIPTION OF THE DRAWINGS

FIGS. 1A-1E are simplified schematics in cross-section of examples of electromagnetic inertial switches, in accordance with some embodiments.

FIGS. 2A-2D are simplified schematics in perspective view of examples of cavity shapes for electromagnetic inertial switches, in accordance with some embodiments.

FIGS. 3A and 3B are simplified schematics in top view of an example of an electromagnetic switch, in accordance with some embodiments.

FIGS. 4A-4C are simplified schematics in perspective view of an example of an electromagnetic inertial switch in three different states, in accordance with some embodiments.

FIGS. 5A and 5B show simplified schematics in perspective cross-section view and exploded view, respectively, of an example of an electromagnetic inertial switch, in accordance with some embodiments.

FIG. 6 is a flow diagram illustrating a method for changing a state of an electromagnetic inertial switch, in accordance with some embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to an electromagnetic inertial switch responsive to an acceleration event of sufficient magnitude. The switch contains an electrically conductive and magnetic mass (e.g., a sphere made of ferritic stainless steel material) located within a cavity. The mass can move to different locations within the cavity, causing the switch to change states. In a first state, the mass is held (i.e., removably coupled) in a first location using a first magnetic field. Upon experiencing an acceleration event of sufficient magnitude (e.g., from 0.5 g to 100 g, where 1 g equals the gravitational acceleration on Earth, or about 9.8 m/s2), the mass is displaced from the first location and is attracted to a second location using a second magnetic field, thereby switching the switch to the second state. Contacts located within the cavity are configured such that when the mass is in the first location the switch is in a first electrical state, and when the mass is in the second location (i.e., after an acceleration event of sufficient magnitude) the switch is in a second electrical state. The switch has different electrical resistances in the first electrical state and the second electrical state, where the electrical resistance in the first state can be greater or less than the electrical resistance of the switch in the second state.

In some cases, the switch contains an electrically conductive and magnetic mass located within a cavity, and before an acceleration event, the mass is suspended in the center (or, is suspended approximately in the center) of the cavity via a first magnetic field (e.g., created by two fixed magnets positioned outside of the cavity, or created by magnets coupled to or within the walls of the cavity). In this state, the mass is in a first location, and the switch is open (i.e., is in a high resistance state). An acceleration event with a sufficient magnitude (i.e., the magnitude of the acceleration during the event is greater than a threshold determined by the design of the switch) will displace the mass from the center of the cavity (i.e., the first location), the mass will be attracted to a second location, and once in the second location the switch will close (i.e., change to a low resistance state). Once the mass is displaced from the center of the cavity due to the acceleration event (and fully or partially escapes the first magnetic field), the force from a second magnetic field attracts the mass to the second location adjacent to the perimeter side(s). The switch closes when the mass is in the second location and contacts an outer (or perimeter) side of the cavity, and is latched in the closed state when the mass is held (i.e., removably coupled) in place (against the outer side, in the second location) by the second magnetic field (e.g., created by another magnet). In some cases, the switch can be reset by removing the second magnetic field (e.g., by moving an assembly containing the magnet away from the cavity, such as by lifting a ring-shaped magnet assembly away from a disk shaped cavity), which allows the mass to return to the center of the cavity (i.e., the first location) due to the force from the first magnetic field.

In some cases, the switch is in a high resistance state when the mass is in the first location and in a low resistance state when the mass is in the second location. In such cases, at least two electrical contacts within the cavity are located such that the electrically conductive mass makes contact with only one electrical contact (or no electrical contacts) when in the first location (i.e., the switch is open), and the mass makes contact with both electrical contacts when in the second location (thereby closing the switch).

In other cases, the switch can be in a low resistance state when the mass is in the first location and in a high resistance state when the mass is in the second location. In such cases, at least two electrical contacts within the cavity are located such that the electrically conductive mass makes contact with two electrical contacts when in the first location (i.e., the switch is closed), and the mass makes contact with only one electrical contact (or no electrical contacts) when in the second location (thereby opening the switch).

In some cases, the cavity has one short axis and two longer axes, and therefore contains one or more major surfaces and one or more perimeter sides. For example, the cavity can have a flat cylindrical (i.e., disk) shape with two circular major surfaces and a curved (ring-shaped) perimeter side. In another example, the cavity can have a right square prism shape with a height of the prism being smaller than a length of a side of the square bases, and therefore contains two square major surfaces and four perimeter sides. In such cases, a portion of the major surfaces of the cavity is electrically conductive and is electrically coupled to a first terminal of the switch, and a portion of the perimeter sides of the cavity is also electrically conductive and is electrically coupled to a second terminal of the switch. Before the acceleration event, the mass is suspended in a first location (e.g., the center of the cavity). In some cases, the mass may make contact with neither conductive portion in this first location, or can make electrical contact with the portion of the major surface(s) of the cavity coupled to the first terminal of the switch. After the acceleration event, the mass can move to a second location and makes electrical contact to both the portion of the major surface(s) of the cavity coupled to the first terminal of the switch and the portion of the perimeter side of the cavity coupled to the second terminal of the switch, which closes the switch. In such cases, therefore, the switch changes from a first electrical state with high resistance to a second electrical state with low resistance in response to the acceleration event.

In other cases, the cavity has one short axis and two longer axes, as described above, but the electrical contacts are positioned such that the switch is in a closed state when the mass is in the first location (e.g., in the center of the cavity), and the switch opens when the mass moves to a second location (e.g., near the perimeter side) in response to the acceleration event.

The materials used to form the electromagnetic inertial switches described herein can be any materials, where at least some of the materials making up the mass are electrically conductive and magnetic, at least some of the materials making up the magnets are magnetic, at least some of the materials making up the contacts and the terminals are electrically conductive, and the materials making up the cavity walls between the contacts have a low electrical conductivity (or are electrically insulating). For example, the mass can be made of a ferritic material such as iron, steel, cobalt, nickel, or alloys thereof, or a magnetic rare-earth alloy. The magnets can be permanent magnets or electromagnets made of ferritic material such as iron, steel, cobalt, nickel, or alloys thereof, or a magnetic rare-earth alloy (e.g., containing neodymium, samarium, and/or cobalt). The contacts and/or terminals can be made of any electrically conductive material such as steel, copper, aluminum, or other metal. In other cases, the contacts and/or terminals can be made of a material (e.g., electrically conductive or insulating) that is coated with a layer of electrically conductive material such as copper, aluminum, or other metal. The wall of the cavity between the contacts can be any material with a relatively low electrical conductivity (compared to the contacts), such as a polymeric material.

In some cases, an acceleration event described herein includes acceleration magnitudes that vary over time. For example, an acceleration event can initially accelerate an electromagnetic inertial switch described herein with a relatively low magnitude of acceleration, and then the magnitude of the acceleration can increase to a maximum acceleration magnitude, and then the acceleration magnitude can decrease before the acceleration event ends. An acceleration event that is sufficient to change the state of an electromagnetic inertial switch described herein can have an acceleration magnitude, or a maximum acceleration magnitude, from 0.5 g to 100 g, or from 0.5 g to 10 g, or from 0.5 g to 50 g, or from 50 g to 100 g, or from 1 g to 100 g, or from 1 g to 10 g, or from 10 g to 50 g. The direction of the acceleration of an electromagnetic inertial switch described herein can also vary over time during an acceleration event. The acceleration event applies forces to a mass within an electromagnetic inertial switch in directions and magnitudes related to the directions and magnitudes of the acceleration during the acceleration event.

The magnitude and spatial distribution of the first and second magnetic fields, and the size and magnetic properties of the mass, are tuned for a certain acceleration threshold of the switch. In some cases, a switch is in a first state and a mass is suspended in a first location in a cavity (e.g., approximately in the center) via a first magnetic field. An acceleration event with a sufficient magnitude displaces the mass from the first location, and the mass is attracted to a second location by a second magnetic field, causing the state of the switch to change to a second state. In some cases, a sufficient acceleration event will apply an inertial force on the mass over a distance that will enable the mass to overcome the forces applied to the mass by the first magnetic field. In other words, a sufficient acceleration event is one that applies an inertial force over a distance on the mass such that the work done on the mass by the acceleration event is sufficient to overcome the force of attraction over a distance applied to the mass by the first magnetic field, where the distances can be from the first location to the second location, or from the first location to an intermediate location between the first and the second location. The total energy that the mass needs in order to overcome the attraction of the first magnetic field (e.g., to move from the first location to the second location) can be referred to as a total energy of magnetic attraction. In some cases, the work done by an acceleration event can be calculated by integrating the force applied on the mass by the acceleration event over a distance within the switch, and the total energy of magnetic attraction can be calculated by integrating the force on the mass from the first magnetic field over a distance within the switch. In such cases, a sufficient acceleration event would do an amount of work on the mass that is greater than the total energy of magnetic attraction over the distance required to move the mass from the first location to the second location. In some cases, the second magnetic field also applies a force on the mass. In such cases, when calculating sufficient acceleration events, the work done on the mass by the inertial force of the acceleration event needs to be larger than the integral of the sum of the forces on the mass from the first and second magnetic fields over a distance within the switch (e.g., from the first location to the second location). In some cases, friction between the mass and the cavity wall(s) can dissipate some energy from the acceleration event, and therefore a sufficient acceleration event is required to do enough work on the mass to overcome the total energy of magnetic attraction (e.g., for one or more magnetic fields) and the energy dissipated due to friction.

Using one or more of the above calculation methods, an electromagnetic inertial switch described herein can be designed for a particular acceleration event threshold by changing the strength and/or spatial distribution of one or more magnetic fields, and/or by changing the size and/or mass of the mass, and/or by changing the distance over which the mass must move to change the state of the switch, and/or by changing the coefficient of friction between the mass and the cavity walls. Additionally, an electromagnetic inertial switch described herein can be designed to be more sensitive to short duration acceleration events (e.g., impulse acceleration events) by localizing the first magnetic field over a shorter distance within the cavity, compared to switches that change state in response to longer duration acceleration events where the first magnetic field can extend over a longer distance within the cavity.

The electromagnetic inertial switches described herein can be used to actuate an electrical or electromechanical system. For example, the present switches can be used as part of an aerial vehicle, such as a lighter than air (LTA) vehicle, to actuate an electrical or electromechanical system upon experiencing an acceleration event of sufficient magnitude, such as an envelope of the LTA vehicle bursting. In another example, the present switches can be used as part of a safety system to actuate an electrical or electromechanical system in response to an acceleration event of sufficient magnitude, such as a vehicular accident. In other cases, the present switches can be used for structural and/or shock measurements in vehicle testing, or in the testing of other types of structures. In some cases, the actuation of the electrical or electromechanical system can comprise sending a signal to the electrical or electromechanical system, while in other cases, the actuation of the electrical or electromechanical system can comprise cutting the power to the electrical or electromechanical system.

In some cases, the electromagnetic inertial switch described above can be utilized to actuate one or more systems of an LTA vehicle. For example, when an envelope of an LTA vehicle unintentionally bursts, the burst can cause the LTA vehicle to experience large accelerations and the present inertial switch can actuate one or more flight termination systems. In some cases, upon experiencing a large acceleration the present electromagnetic switch can actuate a mechanism to deploy a drogue parachute (e.g., in order to prevent the envelope from prematurely collapsing onto components of the LTA vehicle).

The switches described herein operate using a mass that moves within a cavity. In some cases, the mass is round (e.g., spherical or cylindrical) and the mass moves by a combination of sliding and rolling within the cavity. In other cases, the mass is not round (e.g., is shaped like a rectangular prism, a puck, a cylinder, or another shape with a flat surface in contact with the cavity) and therefore slides (not rolls) to move within the cavity. In some cases, lubrication is applied to the interior surfaces of the cavity to reduce friction between the mass and the cavity walls. The lubrication can be in the form of a liquid (e.g., oil), grease, or particulate (e.g., silica) that is applied to the walls of the cavity. In other cases, the walls of the cavity can include structures (e.g., whiskers or other protrusions) to reduce the friction between the mass and the cavity walls.

In some cases, gravity can affect which cavity walls the mass contacts. For example, a mass can be used that is shorter than the height of a cavity, and the switch can be oriented such that gravity pulls the mass to the bottom of the cavity, causing the mass to contact the bottom wall (or contact) of the cavity but not the top wall (or contact) of the cavity. To account for gravity, in some cases, more than one contact can be used on different (e.g., opposing) surfaces within the cavity, such that the mass can contact one of the walls (or contacts) irrespective of the orientation of the switch (e.g., whether the switch is right-side-up or upside-down).

In some embodiments, multiple switches can be combined into a system of switches. For example, multiple switches with different orientations can be combined into a system of switches in order to be sensitive to accelerations in different directions. For example, three switches can be used oriented in orthogonal directions to be sensitive to accelerations with sufficient components in any of the orthogonal directions. In some cases, the switches can be wired into a circuit that can provide information about the direction of a sufficient acceleration event, by providing information about which switch is switched (and/or which contacts within a switch are contacted by the mass) in response to the acceleration event.

### EXAMPLE SYSTEMS

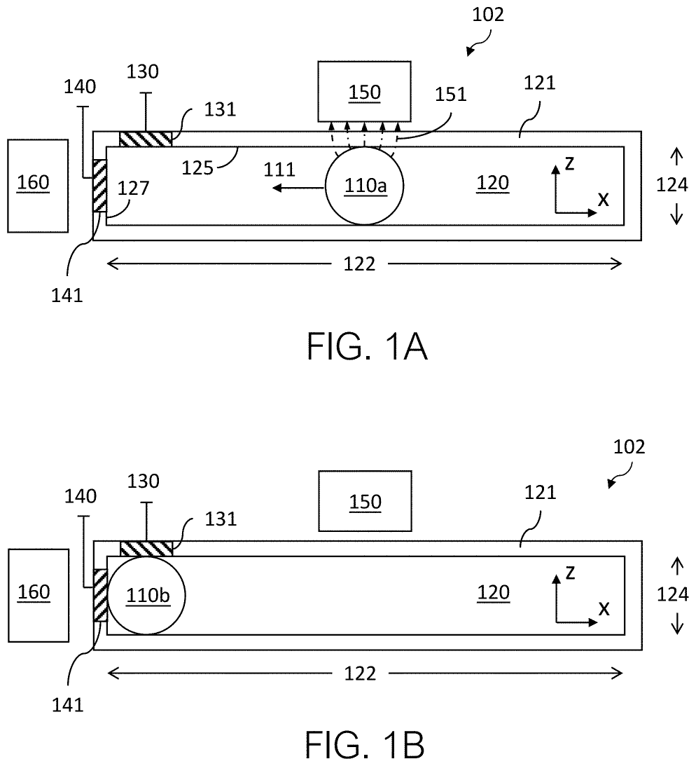

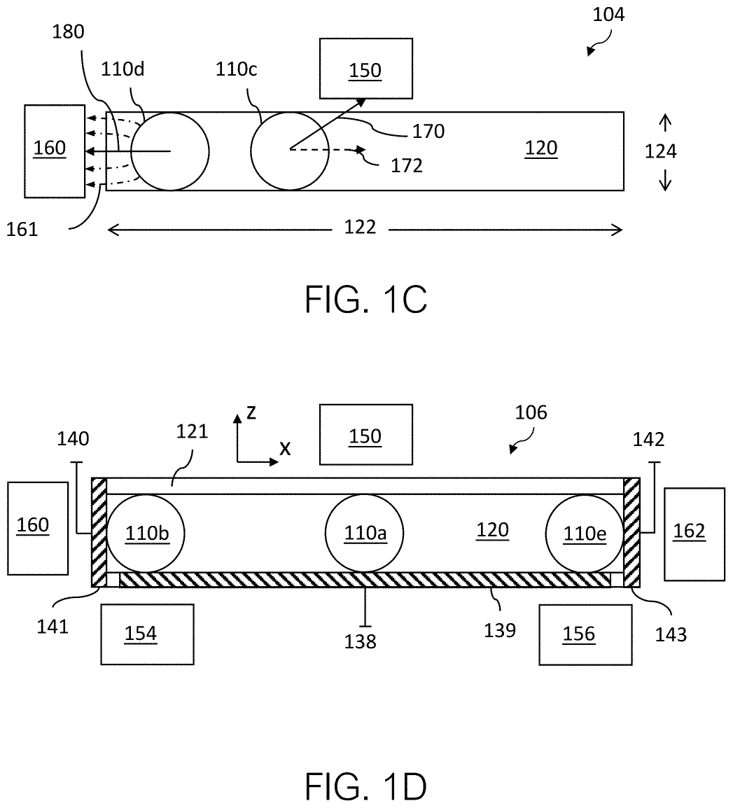

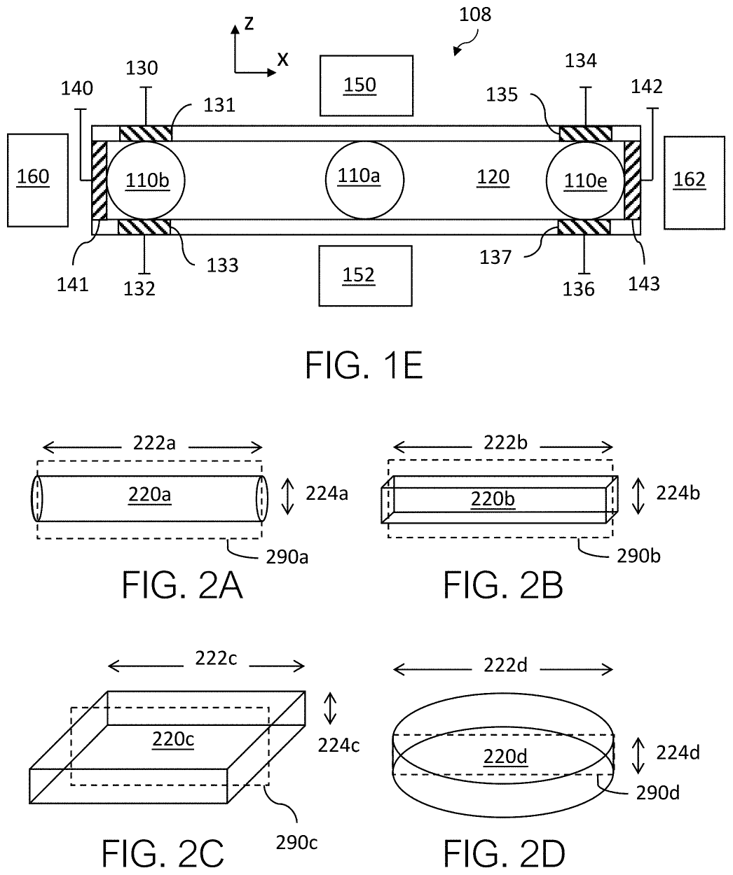

FIG. 1A is a simplified schematic in cross-section view of an example of an electromagnetic inertial switch 102, in accordance with some embodiments. Switch 102 includes a mass 110a that is electrically conductive and magnetic located within a cavity 120, with electrical contacts 131 and 141 coupled to electrical terminals 130 and 140, respectively, a first magnet 150 and a second magnet 160. The mass 110a can move within the cavity 120, and in FIG. 1A is in a first location, being attracted to the first location by magnet 150. Cavity 120 is formed by walls 121 and has a short axis in the z direction (as shown in FIG. 1A) with a height 124 and a long axis in the x direction (as shown in FIG. 1A) with a length 122. Cavity 120, therefore, has a major surface 125 and a perimeter side 127. Cavity 120 can be different shapes while having the cross-section shown in FIG. 1A, as discussed further herein. Electrical contact 131 forms an electrically conductive portion of the major surface 125, and electrical contact 141 forms an electrically conductive portion of the perimeter side 127 of the cavity 120. Terminals 130 and 140 form the external leads of the switch that connect the switch to an electrical or electromechanical system.

FIG. 1A shows the electromagnetic switch in a first state, where the mass 110a is held (i.e., removably coupled) a first location (i.e., approximately in the center of cavity 120) due to the magnetic field 151 between mass 110a and magnet 150. The mass 110a in the first location does not contact electrical contacts 131 or 141 and therefore the switch is in a high resistance state (between terminals 130 and 140). In the first state the mass 110a is suspended within the cavity by the first magnetic field such that the electromagnetic inertial switch is in a high resistance state at rest and in response to an acceleration event less than a threshold acceleration. An acceleration event (e.g., from 0.5 g to 100 g) that causes the switch 102 to experience an acceleration with a component in the positive x direction will impart a force 111 on mass 110a in the negative x direction. If the component of the acceleration of the switch 102 in the positive x direction is sufficient (i.e., greater than a threshold acceleration) and the resulting force 111 is large enough to overcome the force attracting the mass to the magnet 150, then the mass is displaced from the first location.

FIG. 1B is a simplified schematic in cross-section view of the same electromagnetic inertial switch 102 as shown in FIG. 1A, but FIG. 1B shows the switch 102 in a second state, in accordance with some embodiments. After a sufficient acceleration event, the mass is displaced from the first location, the mass is attracted to magnet 160, and the mass 110b is held (i.e., removably coupled) in a second location within the cavity. Mass 110a and mass 110b are the same mass shown in different locations. FIGS. 1A and 1B illustrate that movement of the mass enables the switch to change states in response to the acceleration event. The mass 110b in the second location makes contact with electrical contacts 131 and 141, causing the switch to close in a low resistance state. In this state, there will be a low resistance between terminals 130 and 140 of the switch, because the electrically conductive mass 110b forms a conductive path between contacts 131 and 141. In some embodiments, the electrically conductive mass 110b forms a conductive path between contacts 131 and 141, thereby closing a circuit. The switch can then be reset to a high resistance state by removing magnet 160 (as discussed further herein) allowing the mass 110a to move back to the first location due to the force from the magnetic field between the mass and the magnet 150.

FIG. 1C is a simplified schematic in cross-section view of an example of an electromagnetic inertial switch 104, in accordance with some embodiments. Switch 104 is the same as, or similar to switch 102, and element numbers in FIG. 1C that were described with respect to FIG. 1A have the same function, and may operate the same as, or similar to, each other. FIG. 1C shows the mass in two intermediate locations between the first and second locations. Mass 110c and 110d are the same mass shown in different locations within cavity 120 to further illustrate the forces that the mass experiences at different locations within the cavity 120. Mass 110d is in a location after an acceleration event has displaced the mass from the first location (i.e., the location of mass 110a in approximately the center of the cavity in FIG. 1A), and before the mass has reached the second location (i.e., mass 110b adjacent to a side of the cavity in FIG. 1B). Magnet 160 applies a force 180 on mass 110d due to the magnetic field 161 between the magnet 160 and the mass 110d, attracting the mass to the second location. The magnet 160 can also apply a force that keeps the mass in the second location after the acceleration event, thereby latching the switch in that state.

FIG. 1C also shows the mass 110c in a location after the switch has been reset (e.g., by magnet 160 being moved away from the cavity) and the mass has been displaced from the second location (i.e., the location shown by mass 110b adjacent to a side of the cavity in FIG. 1B) but has not yet reached the first location. In the intermediate location of mass 110c, magnet 150 applies a force 170 on mass 110c, where the force 170 has a horizontal component 172 that causes the mass to return to the first location, thereby resetting the switch.

FIG. 1D is a simplified schematic in cross-section view of an example of an electromagnetic inertial switch 106, in accordance with some embodiments. Element numbers in FIG. 1D that were described with respect to FIGS. 1A-1C have the same function, and may operate the same as, or similar to, each other. Switch 106 is similar to the switch 102 shown in FIGS. 1A-1B, however, the configuration of contacts within cavity 120 has changed. Switch 106 includes contact 139 on a portion of the major surface(s) of cavity 120, a contact 141 on a first portion of a perimeter side of cavity 120, and a third contact 143 on a second portion of a perimeter side of cavity 120. Contacts 139, 141 and 143 form electrically conductive portions of the surfaces of the cavity, and are electrically coupled to terminals 138, 140 and 142, respectively.

The contact 141, in this example, spans the whole height (i.e., in the z direction) of the cavity 120 on one portion of the perimeter side and extends into the walls 121 of the cavity 120. However, there is a gap between contact 141 and contact 139, and contacts 139 and 141 are electrically isolated from one another by the walls 121. In contrast, the contact 141 in the example shown in FIG. 1A spans only a fraction of the height of the cavity 120. In both examples, the contacts are electrically isolated from each other, and the round mass can form a conductive path between the contacts (when in a particular location).

In the example shown in FIG. 1D, the mass can be in the first location, the second location, or a third location, where the mass 110a shows the mass in the first location, mass 110b shows the mass in the second location, and mass 110e shows the mass in the third location. The switch is in a first high-resistance state when mass 110a is in the first location, since the mass is only in contact with contact 139. As described with respect to FIGS. 1A and 1B, after a sufficient acceleration event in the positive x direction (as shown in FIG. 1D) the mass 110b moves to the second location and is held in the second location by magnet 160. In the example shown in FIG. 1D, when the mass 110b is in the second location the switch is in a second low resistance state since mass 110b forms a conductive path between contacts 139 and 141.

Additionally, switch 106 in FIG. 1D can change to a third state in responsive to an acceleration event (of sufficient magnitude) in the negative x direction. In such a case, the mass 110e will move to the third location and be held (i.e., removably coupled) in a third location by magnet 162. In this example, when the mass 110e is in the third location the switch is in a third low resistance state since mass 110e forms a conductive path between contacts 139 and 143. Therefore, in the example shown in FIG. 1D, in addition to switching from a high resistance state to a low resistance state in response to a sufficient acceleration event, switch 106 can provide information about the direction of the acceleration event by monitoring the resistance between terminals 138 and 140 and between terminals 138 and 142. In some cases, terminals 140 and 142 can be electrically tied together and the switch 106 is able to switch from a high resistance state to a low resistance state in response to an acceleration event with a sufficient magnitude in the positive x or the negative x direction.

In some cases of the example shown in FIG. 1D, an additional magnet 154 can be used to help ensure that the mass 110b in the second location makes electrical contact between contacts 139 and 141 no matter which orientation the switch is in (e.g., if the mass is slightly smaller than the height of the cavity and gravity (or inertia) pulls it to the side opposite the contact). Magnet 156 can operate in a similar way to help ensure that that the mass 110e in the third location makes electrical contact between terminals 139 and 143 no matter which orientation the switch is in. In such an example, magnets 160, 162, 154 and 156 would all have to be moved away from cavity 120 to reset the switch 106.

FIG. 1E is a simplified schematic in cross-section view of an example of an electromagnetic inertial switch 108, in accordance with some embodiments. Element numbers in FIG. 1E that were described with respect to FIGS. 1A-1D have the same function, and may operate the same as, or similar to, each other. Switch 108 is similar to the switch 106 shown in FIG. 1D, however, the configuration of contacts within cavity 120 has changed. Switch 108 includes contacts 130, 132, 134 and 136 on portions of the major surface(s) of cavity 120, a contact 141 on a first portion of a perimeter side of cavity 120, and a contact 143 on a second portion of a perimeter side of cavity 120. Contacts 131, 133, 135, 137, 141 and 143 are electrically coupled to terminals 130, 132, 134, 136, 140 and 142, respectively. In this example, the mass can be in the first location, the second location, or the third location, as discussed with respect to FIG. 1D, where the mass 110a shows the mass in the first location, mass 110b shows the mass in the second location, and mass 110e shows the mass in the third location. Magnets 150 and 152 apply forces on the mass to attract it to the first locations, while magnets 160 and 162 apply forces on the mass to attract it to the second and third locations, respectively.

The example shown in FIG. 1E has contacts on opposing sides of the major surface(s) of the cavity 120. In some cases, terminals 130 and 132 can be tied together, and can help ensure that the mass 110b in the second location makes electrical contact between terminals 130/132 and 140 no matter which orientation the switch is in (e.g., if the mass is slightly smaller than the height of the cavity and gravity (or inertia) pulls it to one side). Contacts 135 and 137 can operate in a similar way to help ensure that that the mass 110e in the third location makes electrical contact between terminals 134/136 and 142 no matter which orientation the switch is in.

FIGS. 1A-1E show examples where the magnets (e.g., 150 and 160) are located outside of the cavity 120. In other examples, the magnets, e.g., 150, 152, 154, 156, 160 and/or 162 can be located coupled to the cavity 120, or can be located within the walls of the cavity 120.

FIGS. 1A-1E show cross-section views of various examples of an electromagnetic inertial switch, but one of ordinary skill in the art would understand that these examples may be varied further, depending on the implementation and system.

FIGS. 2A-2D show examples in perspective view of cavity shapes for the electromagnetic inertial switches described herein. The length 222a-d of a relatively long dimension and the height 224a-d of a relatively short dimension of each cavity 220a-d are also shown in FIGS. 2A-2D. FIG. 2A shows a cavity 220a shaped like a cylinder with circular bases having relatively small diameters compared to the length of the cylinder. In this case, the cavity 220a has one major surface that is the interior of the curved side of the cylinder, and two perimeter sides that are the circular bases. FIG. 2B shows a cavity 220b shaped like right rectangular prism with one relatively long dimension and two relatively short dimensions. In this case, the cavity 220b has four major surfaces that contain the relatively long dimensions (i.e., shaped like oblong rectangles in FIG. 2B) and two perimeter sides that do not contain the relatively long dimensions (i.e., that are approximately square in FIG. 2B). FIG. 2C shows a cavity 220c shaped like right rectangular prism with two relatively long dimensions and one relatively short dimension. In this case, the cavity 220c has two major surfaces, and four perimeter sides. FIG. 2D shows a cavity 220d shaped like a cylinder with circular bases having relatively large diameters compared to the height of the cylinder, such that it has two approximately circular major surfaces and a single perimeter side shaped like a ring.

A mass within cavities shaped like those shown in FIGS. 2A and 2B can move from the center of the cavity to one side or another side (e.g., as shown by the first, second and third locations in FIGS. 1D and 1E). In contrast, a mass within cavities shaped like those shown in FIGS. 2C and 2D can move from the center of the cavity to any location adjacent to the perimeter side of the cavity. Correspondingly, switches with cavities 220a-b shaped like those in FIGS. 2A and 2B are sensitive to acceleration events (e.g., from 0.5 g to 100 g) with sufficient components along the lengths 222a-b of the cavity, while switches with cavities 220c-d shaped like those in FIGS. 2C and 2D can be sensitive to any acceleration events with sufficient components parallel to a major surface of the cavity.

Returning to FIGS. 1A-1E that show cross-sections of cavities 120. Any of the FIGS. 1A-1E can correspond to any of the cross-section planes 290a-d of the differently shaped three-dimensional cavities 220a-d in FIGS. 2A-2D. For example, FIG. 1A could be a cross-section of the cylindrical cavity shown in FIG. 2A through plan 290a, or FIG. 1A could be a cross-section of the right prism cavity shown in FIG. 2C through plane 290c.

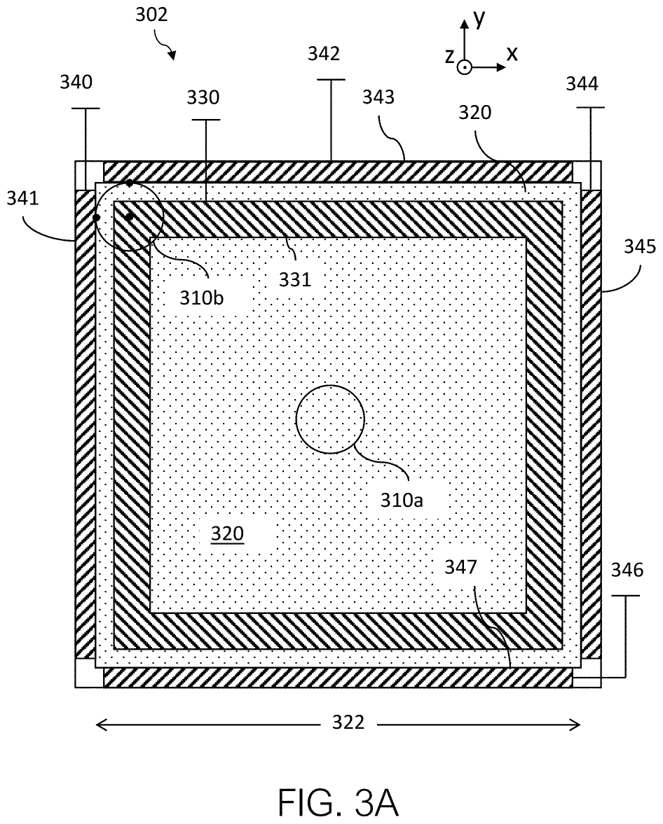

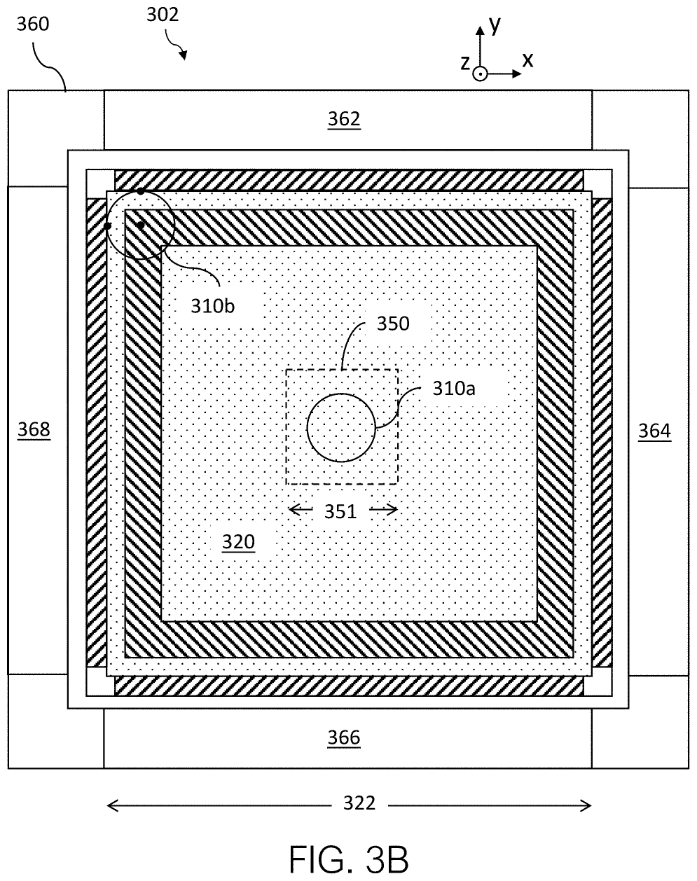

In some embodiments, mass 110a-e may be spherical, cuboid, rectangular cuboid, cylindrical, or other 3D shape. For example, a spherical or cylindrical mass could be used in a switch with a cylindrical cavity such as shown in FIG. 2A, and a cuboid or rectangular cuboid shaped mass could be used in prism shaped cavities such as those shown in FIG. 2B or 2C. In other cases, a spherical or cylindrical mass could be used in a switch with rectangular prism shaped cavities such as those shown in FIG. 2B or 2C (e.g., as shown in FIGS. 3A and 3B).

In some cases, lubrication can be applied to the interior surfaces of any of the cavities shown in FIGS. 2A-2D to reduce friction between the mass and the cavity walls. The lubrication can be in the form of a liquid (e.g., oil), grease, or particulate (e.g., silica) that is applied to the walls of the cavity. In other cases, the walls of any of the cavities shown in FIGS. 2A-2D can include structures (e.g., whiskers or other protrusions) to reduce the friction between the mass and the cavity walls.

FIGS. 2A-2D show perspective views of various examples of cavities for an electromagnetic inertial switch, but one of ordinary skill in the art would understand that these examples may be varied further, depending on the implementation and system.

Multiple switches (e.g., with cavity shapes similar to those shown in FIGS. 2A-2D) can be combined into a system in order to be sensitive to accelerations in different directions. For example, three switches with cavities shaped similar to those in FIG. 2B can be combined into a system where the three switches are oriented in three orthogonal directions in order to be sensitive to accelerations with sufficient components in any of the orthogonal directions. In some cases, the multiple switches can also be wired into a circuit that can provide information about the direction of a sufficient acceleration event, depending on which switch is switched (and the resistance change between different terminals, in some cases) in response to the acceleration event.

FIGS. 3A and 3B are simplified schematics in top views of an example of an electromagnetic switch 302, in accordance with some embodiments. The switch 302 in FIGS. 3A-3B function similarly to the switches shown in the previous examples, and some components of the switch 302 in FIGS. 3A and 3B have been omitted for clarity. FIG. 3A includes mass 110a-b within cavity 320, and electrical contacts 331, 341, 343, 345 and 347, which are electrically coupled to terminals 330, 340, 342, 344 and 346, respectively. FIG. 3B further includes magnet 350 and magnet ring 360, which contains magnets 362, 364, 366 and 368.

FIGS. 3A and 3B show an example with a cavity 320 shaped like a right rectangular prism, similar to the cavity shown in FIG. 2C, with two relatively long dimensions (in the x and y directions as shown in FIG. 3A) and one relatively short dimension (in the z direction, which is coming out of the page, as shown in FIG. 3A). One long dimension 322 is in the x direction is shown in FIG. 3A. The switch 302 contains contact 331 (shaped like an open square, or a square annulus) on a portion of the two major surfaces of cavity 120, contacts 341, 343, 345, and 347 on portions of a first, second, third and fourth perimeter side of cavity 320. In the example shown in FIG. 3A, the mass is in a first location or a second location, where the mass 310a shows the mass in the first location, and mass 310b shows the mass in the second location. In the first location, mass 310a does not contact any of the electrical contacts, and the switch 302 is in a first high resistance state. In the second location, mass 310b contacts electrical contact 331 (i.e., either on the top or the bottom major surface of the cavity 320) and makes contact with electrical contacts 341 and 343, and the switch 302 is in a second low resistance state (i.e., there is a low resistance between terminals 330 and 340, between terminals 330 and 342, and even between terminals 340 and 342. Additionally, in this example if the mass is located in any location making contact with a perimeter side of the cavity then the switch 320 is in a low resistance state.

FIG. 3B shows the positions of the magnets 350, 362, 364, 366, and 368 of switch 302. Magnet 350 is positioned above or below the cavity (i.e., in either the positive or negative z direction, respectively, as shown in FIG. 3B), and has a magnetic field (not shown) that attracts the mass 310a to the first location (approximately in the center of the cavity 320). Magnets 362, 364, 366 and 368 attract the mass to first, second, third and fourth perimeter sides of the cavity, respectively. Magnets 362, 364, 366 and 368 are all coupled to a ring 360 in this example. After an acceleration event of sufficient magnitude to close switch 302, switch 302 can be reset by moving the ring 360 of magnets 362, 364, 366 and 368 up or down (i.e., in either the positive or negative z direction, respectively, as shown in FIG. 3B) out of the plane of the cavity, which will reduce the attraction of the mass to any of the perimeter sides and allow the mass to return to the first location due to the attraction of magnet 350.

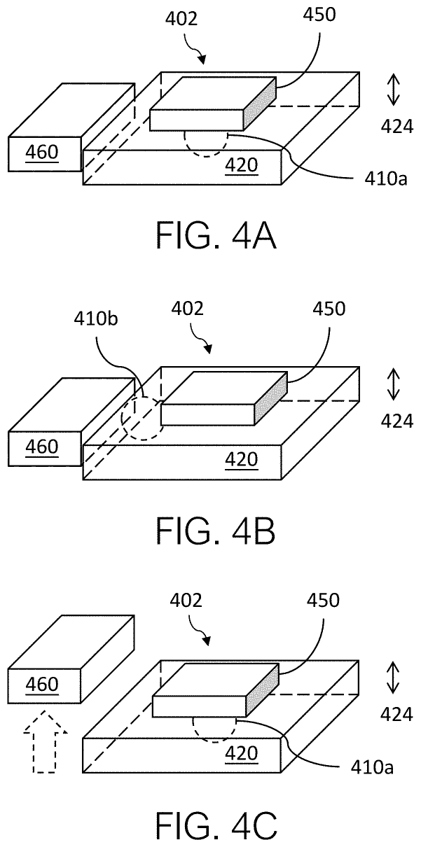

FIGS. 4A-4C show simplified schematics in perspective views of an example of an electromagnetic inertial switch 402 in three different states. Switch 402 has a cavity 420 with a height 424 and a mass 410a-b inside, a first magnet 450 and a second magnet 460. FIG. 4A shows switch 402 in a first state, where the mass 410a is in a first location, attracted to the first location by magnet 450. FIG. 4B shows switch 402 in a second state after a sufficient acceleration event, where the mass 410b is in a second location, attracted to the second location by magnet 460. In some examples, switch 402 has a higher resistance in the first state, and a lower resistance in the second state, while in other examples the switch 402 has a lower resistance in the first state, and a higher resistance in the second state, depending on the configuration of contacts within the cavity 420 (as describe herein). FIG. 4C shows the switch 402 after it has been reset by lifting magnet 460 out of the plane of the cavity 420, which allowed the mass 410a to return to the first location due to the attraction of magnet 450.

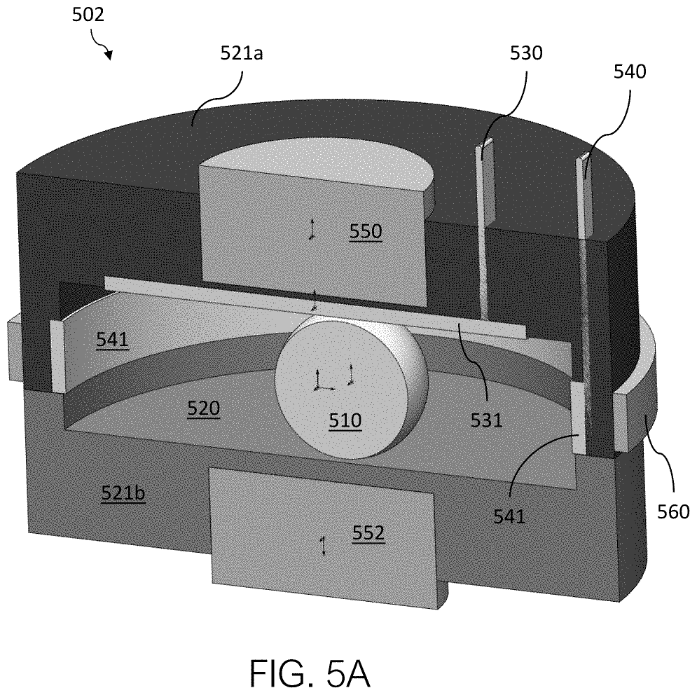

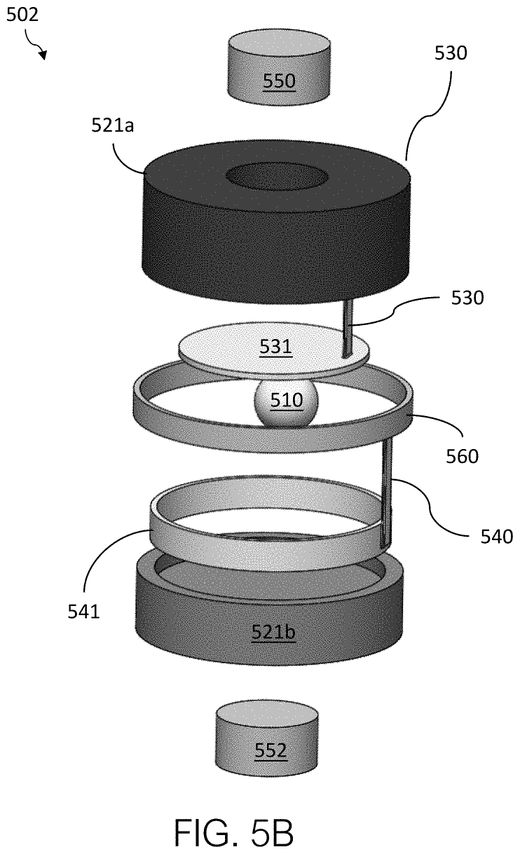

FIGS. 5A and 5B show simplified schematics of an example of an electromagnetic inertial switch 502 in perspective cross-section view and exploded view, respectively. Switch 502 contains a mass 510 contained within a cavity 520 formed by walls 521a and 521b, electrical contacts 531 and 541 coupled to terminals 530 and 540, respectively, and magnets 550, 552 and 560. Cavity 520 has a cylindrical shape with approximately circular bases, where the diameters of the approximately circular bases are longer than the height of the cavity 520, and therefore cavity 520 has two approximately circular major surfaces and a curved perimeter side shaped like a ring. Switch 520 operates similarly to switches described above. FIG. 5A shows the switch 502 in a first high resistance state since mass 510 is in a first location (attracted by magnets 550 and 552) and contacts electrical contact 531. After a sufficient acceleration event, the switch 502 will be in a second low resistance state, where the mass will be in a second location adjacent to the perimeter side (attracted by magnet 560) and will form a conductive path between contacts 531 and 541. To reset switch 502 after a sufficient acceleration event, magnet 560 is moved up or down with respect to the cavity such that the attraction between magnet 560 and the mass is reduced, and the mass is returned to the first location due to the attraction from magnet 550.

### EXAMPLE METHODS

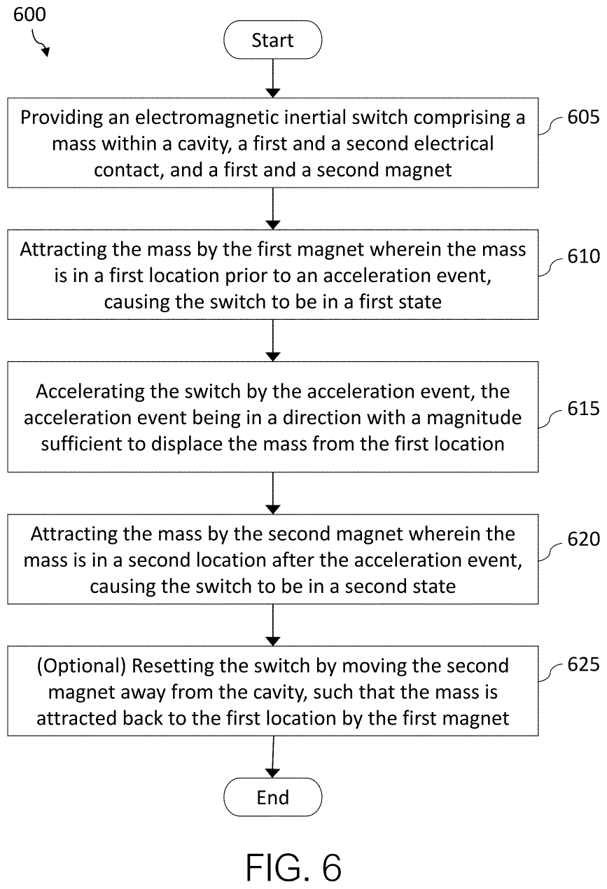

FIG. 6 is a flow diagram illustrating a method 600 for changing a state of an electromagnetic inertial switch, in accordance with some embodiments. In step 605, an electromagnetic inertial switch is provided comprising a mass within a cavity, a first and a second electrical contact, and a first and a second magnet (e.g., as described in any of the embodiments above, and/or as shown in any of FIGS. 1A-1E, 2A-2D, 3A-3B, 4A-4C, and/or 5A-5B). For example, the cavity can be shaped like the cavities shown in FIGS. 2A-2D, and the configuration of contacts and magnets can be any configuration describe herein. The mass is electrically conductive and magnetic, and can move within the cavity. In step 610, the mass is attracted to the first magnet such that the mass is in a first location prior to an acceleration event, causing the switch to be in a first state. In step 615, the switch experiences the acceleration event that physically accelerates the switch in a direction with a magnitude sufficient to displace the mass from the first location. In step 620, the mass is attracted to the second magnet such that the mass is in a second location after the acceleration event, which causes the switch to be in a second state.

In some cases of method 600, the first state is a high resistance state where the mass does not form a conductive path between the first and second contact in the first location (and the first and second contacts do not touch one another), and the second state is a low resistance state where the mass does form a conductive path between the first and second contact in the second location. In other cases of method 600, the first state is a low resistance state where the mass forms a conductive path between the first and second contact in the first location, and the second state is a high resistance state where the mass does not form a conductive path between the first and second contact in the second location (and the first and second contacts do not touch one another).

In optional step 625, the switch is reset from the second state back to the first state by moving the second magnet away from the cavity, such that the mass is attracted back to the first location by the first magnet. (e.g., as discussed above, and/or as shown in FIG. 4C).

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. An electromagnetic inertial switch, comprising:
a mass that is electrically conductive and magnetic;
a cavity comprising a major surface and a perimeter side, wherein:
a portion of the major surface of the cavity is electrically conductive and is electrically coupled to a first terminal of the electromagnetic inertial switch, and
a portion of the perimeter side of the cavity is electrically conductive and is electrically coupled to a second terminal of the electromagnetic inertial switch;
a first magnetic field configured to apply a first force on the mass to attract the mass towards the center of the cavity; and
a second magnetic field configured to apply a second force on the mass to attract the mass towards the portion of the perimeter side;
wherein:
the mass being suspended within the cavity by the first magnetic field such that the electromagnetic inertial switch is in a high resistance state at rest and in response to an acceleration event less than a threshold acceleration; and
the mass being configured to be displaced from the center of the cavity, and held against the perimeter side by the second magnetic field, the mass further configured to make electrical contact with both the portion of the major surface and the portion of the perimeter side such that the electromagnetic inertial switch is in a low resistance state in response to an acceleration event greater than a threshold acceleration.

2. The electromagnetic inertial switch of claim 1, wherein the electromagnetic inertial switch is configured to be reset to the high resistance state by moving the second magnetic field away from the cavity such that the first magnetic field causes the mass to be suspended within the center of the cavity.

3. The electromagnetic inertial switch of claim 1, wherein the mass closes a circuit by forming a conductive path between the portion of the major surface and the portion of the perimeter side.

4. The electromagnetic inertial switch of claim 1, wherein the mass is approximately spherical.

5. The electromagnetic inertial switch of claim 1, further comprising a second major surface of the cavity, wherein:
a portion of the second major surface of the cavity is electrically conductive and is electrically coupled to a third terminal of the electromagnetic inertial switch; and
the portion of the major surface of the cavity and the portion of the second major surface of the cavity are located on opposing sides of the cavity.

6. The electromagnetic inertial switch of claim 1, further comprising:
a second portion of the perimeter side that is electrically conductive and is electrically coupled to a third terminal of the electromagnetic inertial switch; and
a third magnetic field configured to apply a second force on the mass to attract the mass towards the second portion of the perimeter side.

7. The electromagnetic inertial switch of claim 1, wherein the cavity is shaped like a cylinder with circular bases having relatively small diameters compared to the length of the cylinder.

8. The electromagnetic inertial switch of claim 1, wherein the cavity is shaped like a right rectangular prism with one relatively long dimension and two relatively short dimensions.

9. The electromagnetic inertial switch of claim 1, wherein the cavity is shaped like a cylinder with circular bases having relatively large diameters compared to the height of the cylinder.

10. The electromagnetic inertial switch of claim 1, wherein the acceleration event has a magnitude of approximately 0.5 g to 100 g.

11. The electromagnetic inertial switch of claim 1, wherein the electromagnetic inertial switch is coupled to a lighter than air vehicle and configured to actuate a flight termination system in response to an acceleration event greater than a threshold acceleration.

12. A method of actuating an electrical system in response to an acceleration event, comprising:
providing an electromagnetic inertial switch comprising an electrically conductive and magnetic mass located within a cavity, a first electrical contact, a second electrical contact, a first magnet, and a second magnet;
attracting the mass to the first magnet, wherein the mass is held in a first location prior to an acceleration event, causing the switch to be in a first state;
accelerating the switch by the acceleration event, the acceleration event being in a direction and having a magnitude sufficient to displace the mass from the first location; and
attracting the mass to the second magnet, wherein the mass is held in a second location after the acceleration event, causing the switch to be in a second state,
wherein the mass forms a conductive path between the first electrical contact and the second electrical contact in the second state, the conductive path being configured to actuate an electrical system.

13. The method of claim 12, further comprising resetting the electromagnetic inertial switch by moving the second magnet away from the cavity, such that the mass is attracted back to the first location by the first magnet.

14. The method of claim 12, wherein the mass is approximately spherical.

15. The method of claim 12, wherein the first electrical contact comprises a portion of a major surface of the cavity that is electrically conductive and the second electrical contact forms a portion of a perimeter side of the cavity that is electrically conductive.

16. The method of claim 12, wherein the cavity is shaped like a cylinder with circular bases having relatively small diameters compared to the length of the cylinder.

17. The method of claim 12, wherein the cavity is shaped like a right rectangular prism with one relatively long dimension and two relatively short dimensions.

18. The method of claim 12, wherein the cavity is shaped like a cylinder with circular bases having relatively large diameters compared to the height of the cylinder.

19. The method of claim 12, wherein the magnitude of the acceleration of the switch is from 0.5 g to 100 g.

20. The method of claim 12, wherein the electromagnetic inertial switch is coupled to a lighter than air vehicle and actuates a flight termination system in response to an acceleration event greater than a threshold acceleration.
